(19) United States
(12) Patent Application Publication
(10) Pub. No.: US 2022/0372907 A1
(43) Pub. Date: Nov. 24, 2022

(54) FLUIDIC CONTROL DEVICE OF A VEHICLE

(71) Applicant: INDUSTRIE SALERI ITALO S.P.A., Lumezzane (Brescia) (IT)

(72) Inventors: Alfonso SURACE, Lumezzane (Brescia) (IT); Marco PEDERSOLI, Lumezzane (Brescia) (IT); Simone CORNACCHIA, Lumezzane (Brescia) (IT)

(21) Appl. No.: 17/642,830

(22) PCT Filed: Sep. 16, 2020
(86) PCT No.: PCT/IB2020/058594

§ 371 Date: Mar. 14, 2022

(30) Foreign Application Priority Data
Oct. 14, 2019 (IT) 102019000018713

(51) Int. Cl. F01P 5/10; F01P 7/16; B60L 58/26; H02K 5/20; H02K 9/193

(52) U.S. Cl. CPC F01P 5/10; F01P 7/16; B60L 58/26; H02K 5/203; H02K 9/193; F01P 2005/105; F01P 2007/146

(57) ABSTRACT

A fluidic control device of a thermal management assembly of a thermal regulation system of a vehicle has three operating groups. The thermal management assembly has first and second pump groups, fluidically connected by an auxiliary duct. The fluidic control device, fluidically connected to the first and second pump groups, and to the auxiliary duct, has three outlets, connectable to the three operating groups, respectively, and is configurable in a first working configuration in which flow of working fluid is regulated through the first and second outlets, preventing flow through the third outlet and the auxiliary duct, a second working configuration in which flow of working fluid is regulated through the third outlet, preventing flow through the first and second outlets and the auxiliary duct, and a third working configuration in which flow of working fluid is regulated through the auxiliary duct, preventing flow through the first and third outlets.

### CROSS-REFERENCE TO RELATED APPLICATIONS

This application is a National Phase Application of PCT International Application No. PCT/IB2020/058594, having an International Filing Date of Sep. 16, 2020 which claims priority to Italian Application No. 102019000018713 filed Oct. 14, 2019, each of which is hereby incorporated by reference in its entirety.

### FIELD OF THE INVENTION

The present invention relates to a fluidic control device of a thermal management assembly of a thermal regulation system of a vehicle. Additionally, the present invention relates to a thermal management assembly which comprises said fluidic control device. Furthermore, the present invention relates to the thermal regulation system of a vehicle which comprises said thermal management assembly. Finally, the present invention further relates to a vehicle, which comprises said thermal regulation system.

In other words, the present invention relates to the automotive field and in detail the thermal regulation system of a vehicle. In particular, the term “vehicle” refers to any means of transport without any limitation as to type or size, i.e. a motor car or a semi-articulated vehicle.

### BACKGROUND OF THE INVENTION

The need to manage the temperature of the operating groups of the vehicle to take them to and/or keep them in the best possible operating conditions (by cooling and/or heating them) is known in the prior art. In particular, hereinafter, “operating group” means a specific component or group of components for carrying out a given operation necessary for the motion of the vehicle. Therefore, for example, operating group means the endothermic engine group, or the battery group, or the gearbox group, or the transmission group, or the electric motor group for the management of the battery group.

In recent years, a multitude of hybrid-powered vehicle solutions has been suggested, in which a plurality of operating groups, such as the endothermic engine group, the battery group, and the electric motor group connected to said battery group, are necessarily present, each operating group having different needs. Indeed, each of said operating groups has a mutually different operating behavior, both while the vehicle is in motion and when it is stationary (e.g. the electric motor operating in situations with the endothermic engine in standby). Therefore, it is apparent that each operating group has different thermal management needs, for cooling and/or heating, as a function of the different operating situations of the vehicle.

Vehicle solutions are thus known which comprise a specific thermal regulation system for each operating group, in which a specific amount of working fluid circulates. In such embodiments, each specific thermal regulation system is designed independently, requiring specific components (e.g. specific pump groups).

In this context, the problem of having, managing, having, and producing a plurality of thermal regulation systems in the same vehicle is thus apparent.

Therefore, the main problem present in this field is that of having, accommodating, and managing a multitude of components necessary for the thermal management of each envisaged operating group on the same vehicle.

Given the above, the need to solve the aforesaid technical problems is strongly felt.

### SUMMARY OF THE INVENTION

Therefore, it is the object of the present invention to provide a new fluidic control device by means of which this need is satisfied.

Such an object is achieved by a fluidic control device, a thermal management assembly, a thermal regulation system of a vehicle, and a vehicle as described and claimed herein.

Preferred variants implying further advantageous aspects are also described.

### BRIEF DESCRIPTION OF THE DRAWINGS

Further features and advantages of the invention will become apparent from the description provided below of preferred embodiments thereof, given by way of non-limiting examples, with reference to the accompanying drawings, in which:

FIG. 1 diagrammatically shows a thermal regulation system according to an embodiment of the present invention;

FIG. 2 diagrammatically shows the thermal regulation system according to a further embodiment of the present invention;

FIG. 3 diagrammatically shows the thermal regulation system according to yet another preferred embodiment of the present invention;

FIGS. 4′, 4″ and 4″ diagrammatically show three views of the thermal regulation system according to the embodiment shown in FIG. 3, in three respective different operating configurations;

FIGS. 5a and 5b show two perspective views of the thermal management assembly of the present invention according to a third preferred embodiment;

FIG. 6 is a side view of the thermal management assembly in FIGS. 5a and 5b;

FIG. 7 is a longitudinal section view of the thermal management assembly in FIG. 6;

FIGS. 8a and 8b are two cross-sectional views of the thermal management assembly taken along the section planes V-V and VI-VI in FIG. 6;

FIG. 9 shows a perspective view with parts separated of the fluidic control device included in the thermal management assembly shown in the figures above.

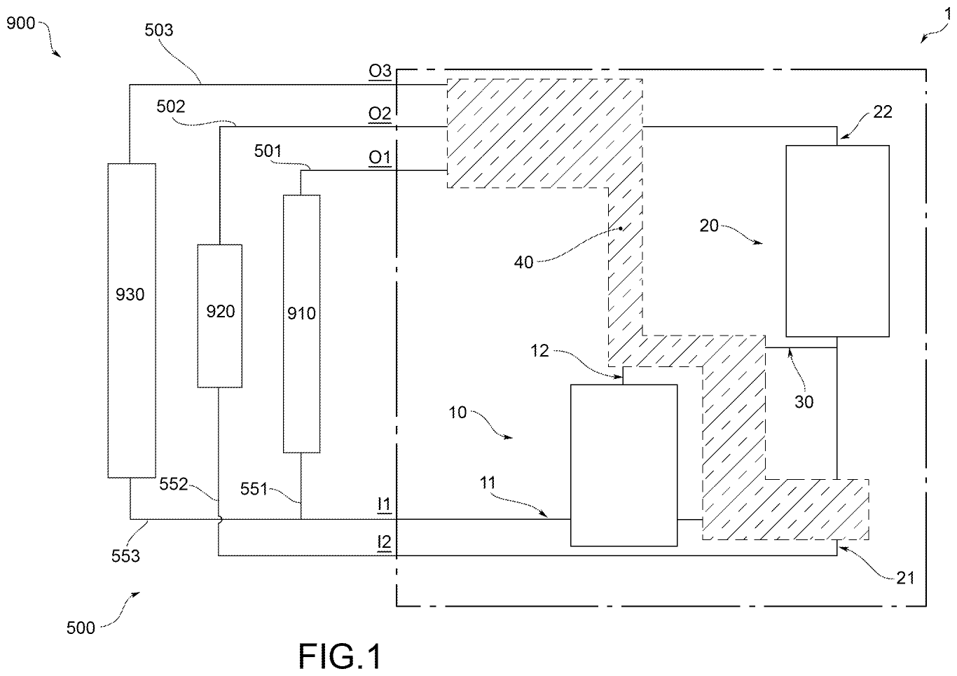

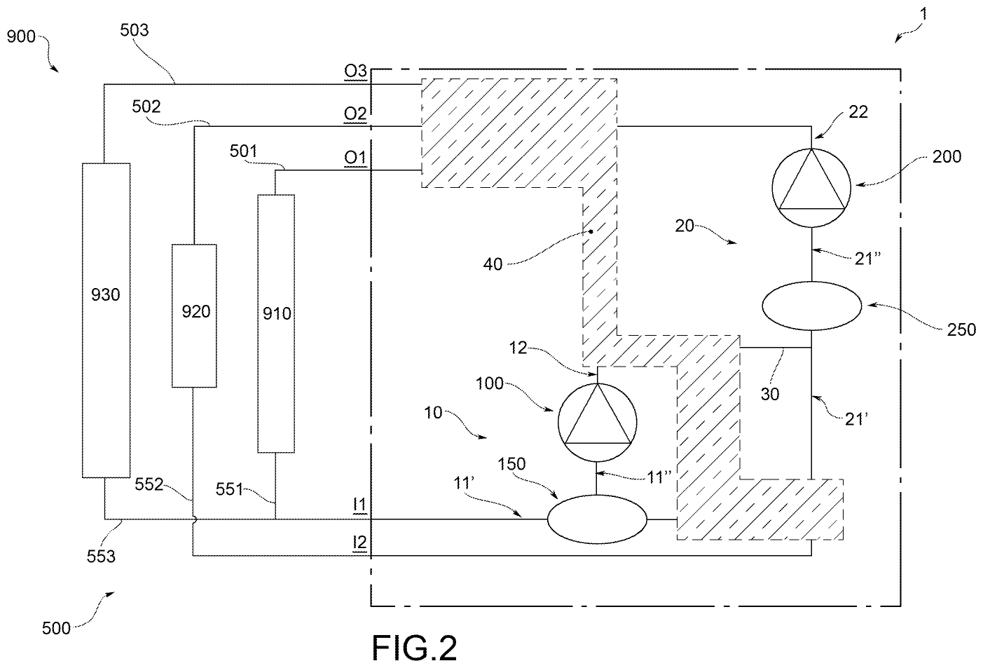

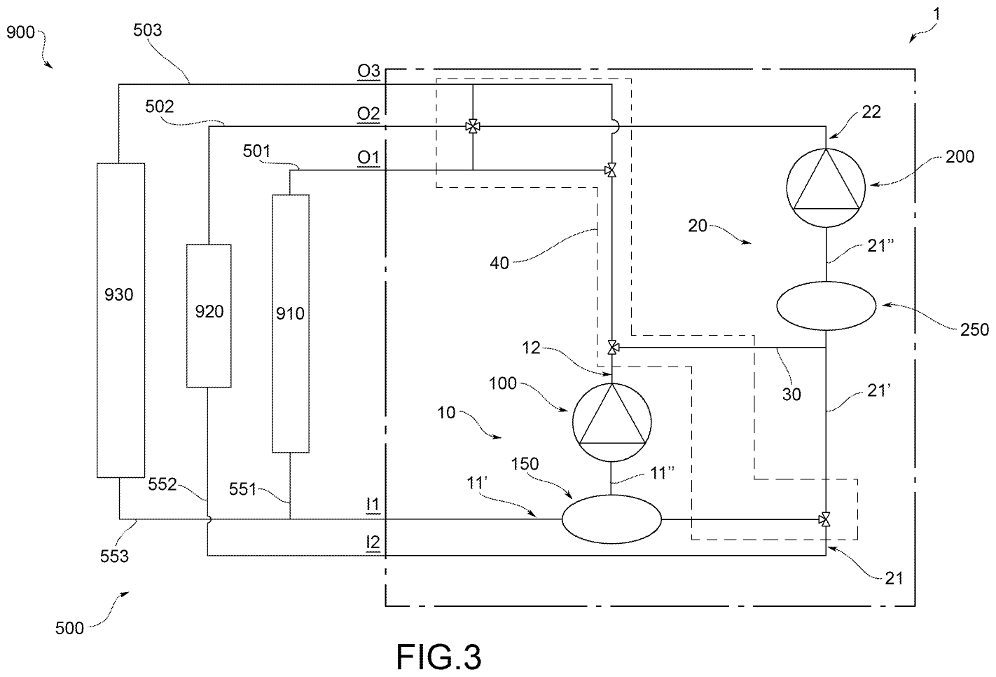

### DETAILED DESCRIPTION

In the appended figures, reference numeral 1 indicates as a whole a thermal management assembly of a thermal regulation system 500 of a vehicle 900, according to a preferred embodiment of the present invention.

In the appended figures, reference numeral 500 indicates a thermal regulation system 500 which comprises the thermal management assembly 1.

A vehicle 900 which comprises the thermal regulation system 500 is not shown, except diagrammatically, but is also the subject of the present invention. Preferably, said vehicle 900 is hybrid-powered, i.e. it combines both the power supply of an electric motor group and the power supply of a battery group.

Preferably, the vehicle 900 comprises a first operating group 910, a second operating group 920, and a third operating group 930.

Each operating group corresponds to a “load”. In particular, each operating group corresponds to a respective component or group of components included in the vehicle 900 and preferably belonging to the power supply of the vehicle 900.

Preferably, the first operating group 910 is an electric motor group.

Preferably, the second operating group 920 is a battery group.

Preferably, the third operating group 930 is an endothermic engine group.

According to the present invention, the first operating group 910, the second operating group 920, and the third operating group 930 are fluidically connected to the thermal regulation system 500, i.e. fluidically connected to the thermal management assembly 1.

Preferably, the first operating group 910, the second operating group 920, and the third operating group 930 are fluidically connected by means of a plurality of system ducts 501, 502, 503, 551, 552, 553 included in the thermal regulation system 500. Preferably, the thermal regulation system 500 further comprises specific heat exchanger groups (not shown).

According to a preferred embodiment, the thermal regulation system 500 comprises at least one system inlet duct and at least one system outlet duct in fluidic connection with each operating group.

According to a preferred embodiment, the thermal management assembly 1 comprises a first pump group 10 suitable to control the motion of the working fluid comprising a first inlet duct 11 and a first outlet duct 12;

According to a preferred embodiment, the thermal management assembly 1 comprises a second pump group 20 suitable, in turn, to control the motion of the working fluid comprising a second inlet duct 21 and a second outlet duct 22.

According to a preferred embodiment, the first pump group 10 comprises a first control unit 100 comprising a first impeller which intercepts the working fluid flowing in the first inlet duct 11 to send it into the first outlet duct 12. Preferably, said first impeller is of the radial type, aspirating working fluid axially through the first inlet duct 11 to push it out tangentially towards the first outlet duct 12.

According to a preferred embodiment, the first pump group 10 further comprises a first stabilization tank 150 which divides the first inlet duct 11 into a first duct upstream section 11′ and a first duct downstream section 11″. In particular, said first stabilization tank 150 unifies the pressure of the flowing liquid before it reaches the first impeller included in the first control unit 100.

In other words, the working fluid reaches the first control unit 100 after having flowed in the first stabilization tank 150.

According to a preferred embodiment, the second pump group 20 comprises a second control unit 200 comprising a second impeller which intercepts the working fluid flowing in the second inlet duct 21 to send it into the second outlet duct 22. Preferably, said second impeller is of the radial type, aspirating working fluid axially through the second inlet duct 21 to push it out tangentially towards the second outlet duct 22.

According to a preferred embodiment, the second pump group 20 further comprises a second stabilization tank 250, which divides the second inlet duct 21 into a second duct upstream section 21′ and a second duct downstream section 21″. In particular, the second stabilization tank 250 unifies the pressure of the flowing liquid before it reaches the second impeller included in the second control unit 200.

In other words, the working fluid reaches the second control unit 200 after having flowed in the second stabilization tank 250.

According to a variant, the thermal management assembly 1 comprises a single fluid stabilization tank fluidically connected to both the first pump group 10 and the second pump group 20.

According to a variant, furthermore, the thermal management assembly 1 comprises an auxiliary duct 30 which fluidically connects the first pump group 10 and the second pump group 20.

Preferably, the auxiliary duct 30 fluidically connects the first outlet duct 12 to the second inlet duct 21.

Preferably, the auxiliary duct 30 fluidically connects the first outlet duct 12 to the second inlet duct 21, upstream of the second stabilization tank 250, i.e. preferably in the second duct upstream section 21′.

According to a preferred embodiment, in a predefined configuration, the first pump group 10 and the second pump group 20 are fluidically arranged in series by means of said auxiliary duct 30.

According to a preferred embodiment, the thermal management assembly 1 further comprises, a first inlet I1 and a second inlet 12 fluidically connected to the first inlet duct 11 and the second inlet duct 21, respectively.

Preferably, said first inlet I1 and second inlet 12 are fluidically connectable to the first operating group 910, the second operating group 920, and the third operating group 930. Preferably, indeed, first inlet I1 and said second inlet 12 are fluidically connectable to the system outlet ducts 551, 552, 553 included in the thermal regulation system 500.

According to a preferred embodiment, at least two outlet system ducts 551, 552, 553 are fluidically connected upstream of either the first inlet I1 or the second inlet 12 so that the working fluid flows into the same inlet upstream thereof.

In some variants, the thermal management assembly 1 further comprises other system inlets that are fluidically connectable to the system ducts.

The present invention relates to a fluidic control device 40 suitable to control the direction of predetermined amounts of working fluid. Preferably, the fluidic control device 40 is suitable to be part of the aforesaid thermal management assembly 1 being fluidically connectable to the aforesaid components. Preferably, the fluidic control device 40 is suitable to be fluidically connectable to the described pump groups and the described operating groups.

According to the present invention, the fluidic control device 40 comprises a first outlet O1, a second outlet O2 and a third outlet O3.

Preferably, said first outlet O1, said second outlet O2 and said third outlet O3 are fluidically connectable to the first operating group 910, the second operating group 920, and the third operating group 930, respectively. In other words, with thermal regulation system 500 installed in the vehicle 900, the working fluid flowing out of one of the three outlets flows to a respective operating group.

Furthermore, said first outlet O1, said second outlet O2 and said third outlet O3 are fluidically connected to the first outlet duct 12 and to the second outlet duct 22.

In particular, the fluidic control device 40 is suitable to manage the working fluid flow modes to an outlet (preventing the flow to the others) or to more than outlet at the same time.

In particular, the fluidic control device 40 is fluidically connectable to the first pair of ducts 11, 12 the second pair of ducts 21, 22, and the auxiliary duct 30. In this manner, the fluidic control device 40 is suitable to manage through which of these pipes the working fluid flows.

In particular, the fluidic control device 40 is fluidically connectable to the first outlet duct 12 and the second outlet duct 22. Preferably, the fluidic control device 40 is also fluidically connectable to the first inlet duct 11 and/or the second inlet duct 21.

Furthermore, the fluidic control device 40 is fluidically connectable to the auxiliary duct 30.

According to the present invention, the fluidic control device (40) is configurable in:

a first working configuration, in which the flow of the working fluid, e.g. moved both by the first pump group 10 and by the second pump group 20, is regulated through the first outlet O1 and the second outlet O2, and the flow of the working fluid through the third outlet O3 and the auxiliary duct 30 is prevented;

a second working configuration, in which the flow of the working fluid, e.g. moved both by the first pump group 10 and by the second pump group 20, is regulated through the third outlet O3 and the flow of the working fluid through the first outlet O1, through the second outlet O2, and through the auxiliary duct 30 is prevented;

a third working configuration, in which the flow of the working fluid, e.g. moved from the first pump group 10 to the second pump group 20, is regulated through the auxiliary duct 30 and the flow of the working fluid exiting through the second outlet O2 is regulated, while the flow of the working fluid through the first outlet O1 and through the third outlet O3 is prevented.

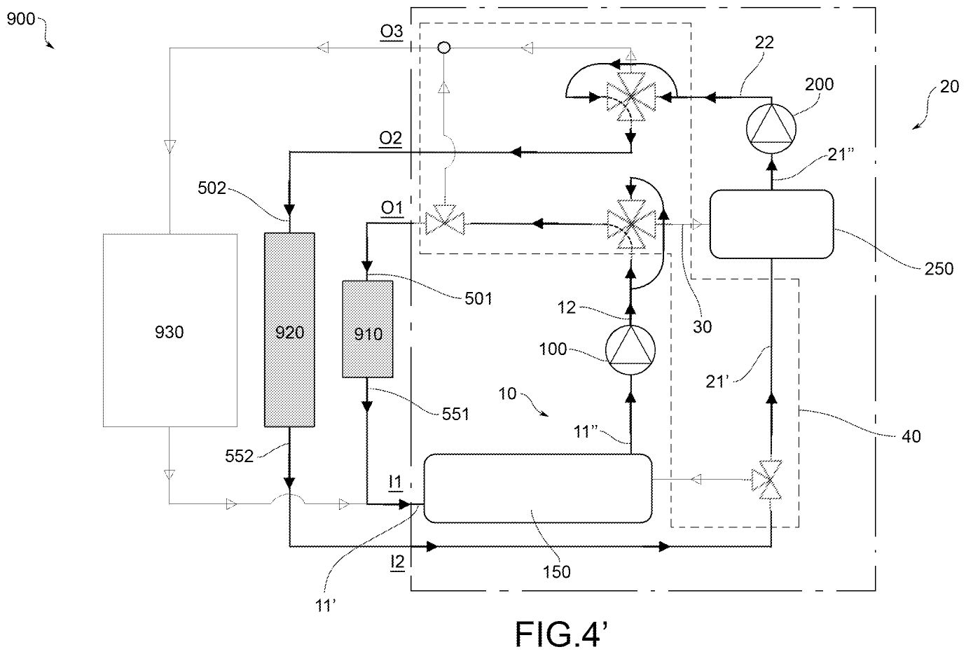

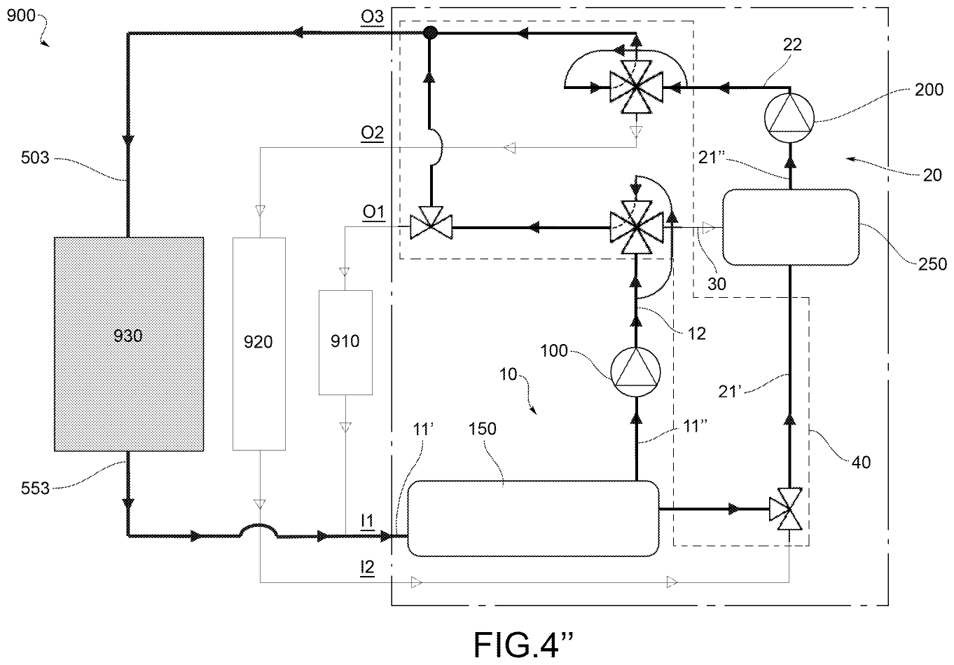

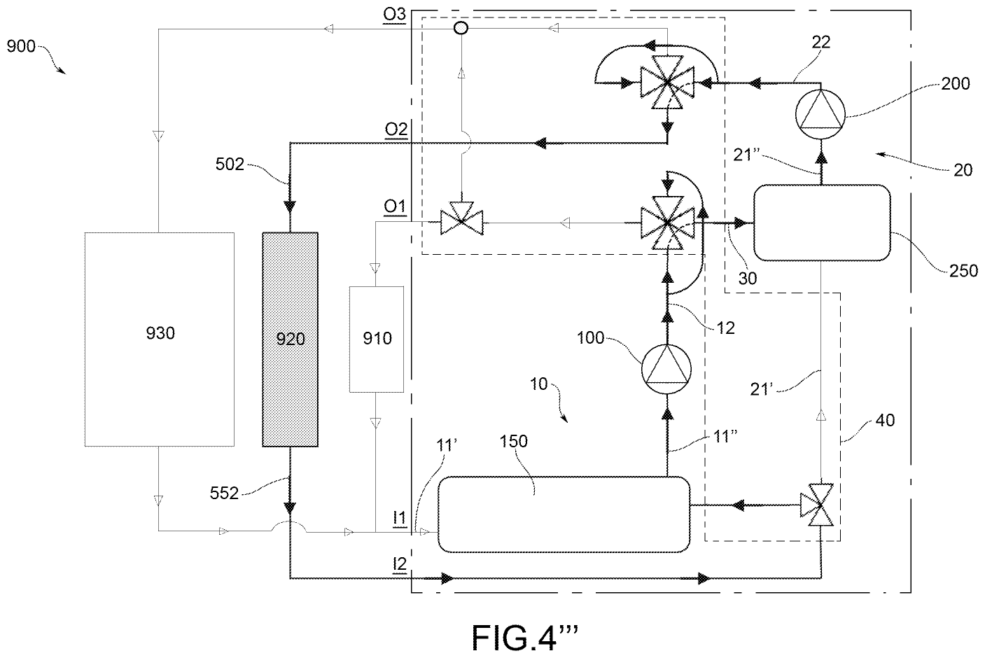

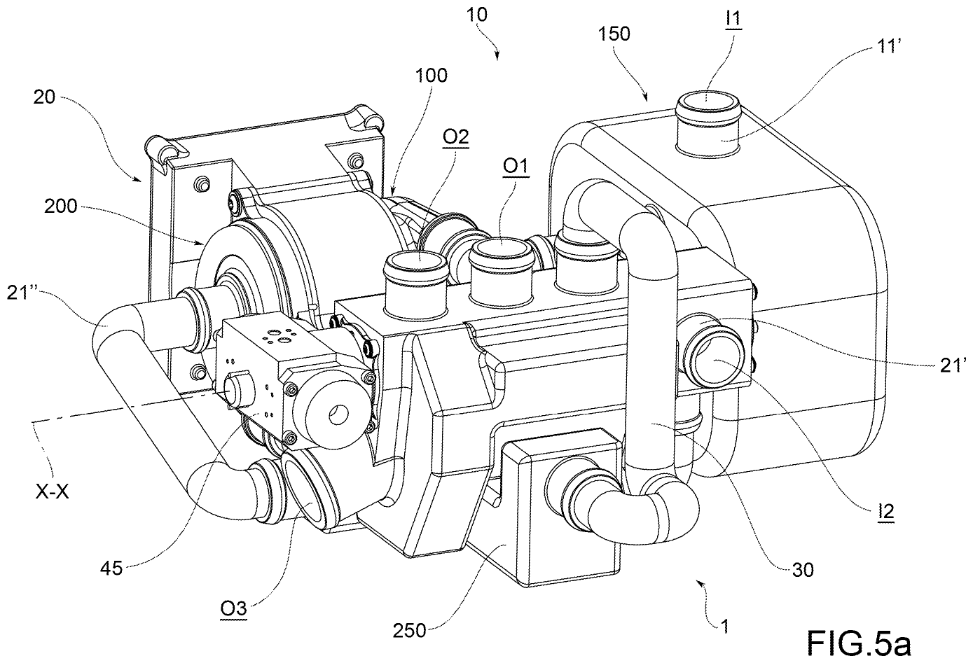

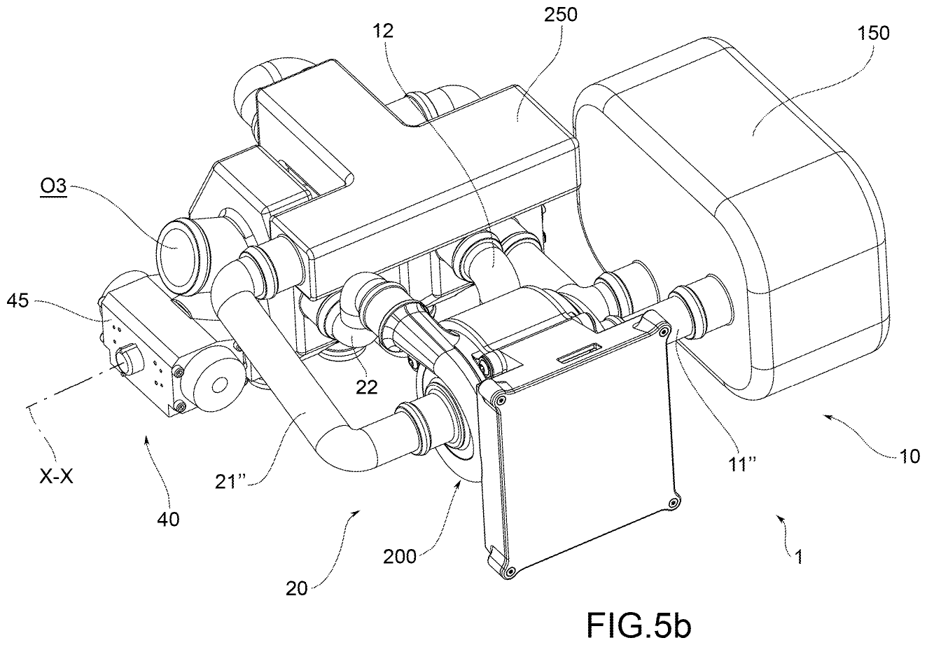

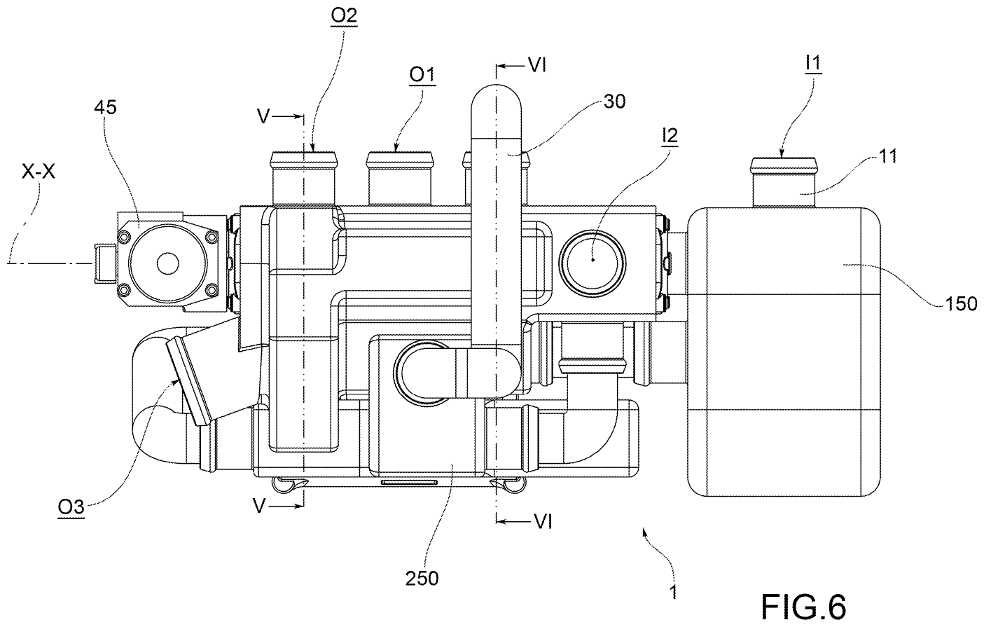

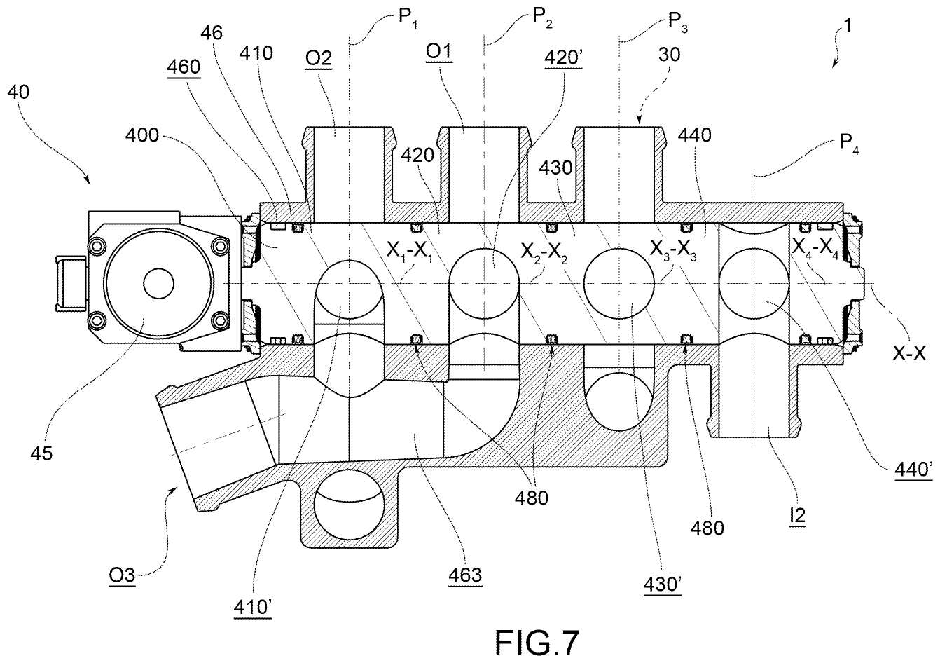

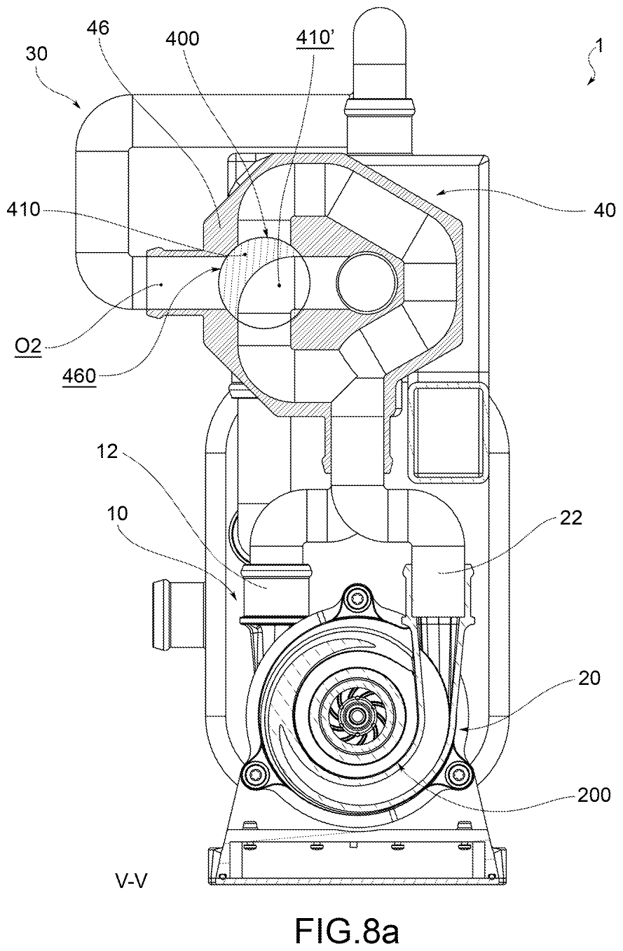

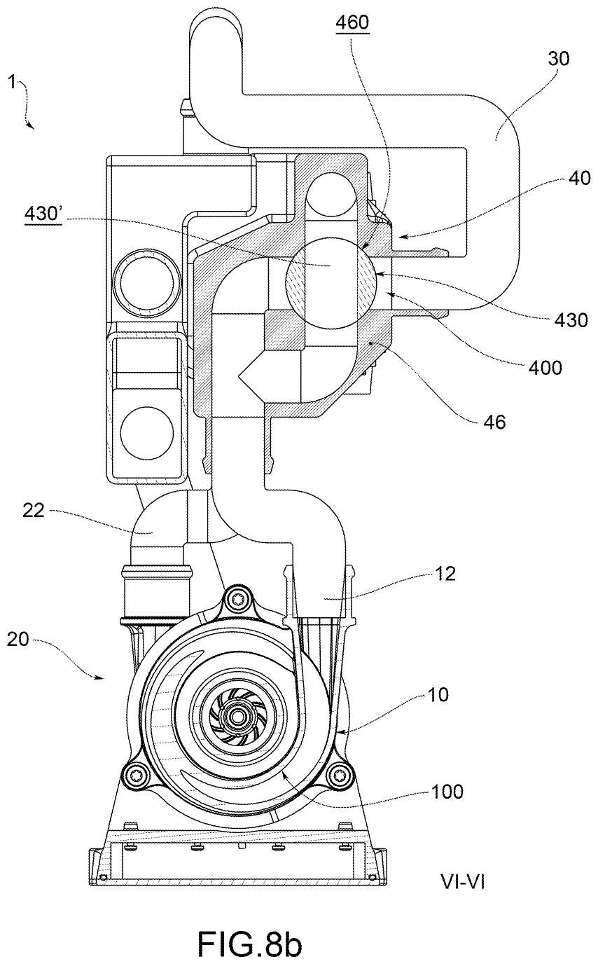

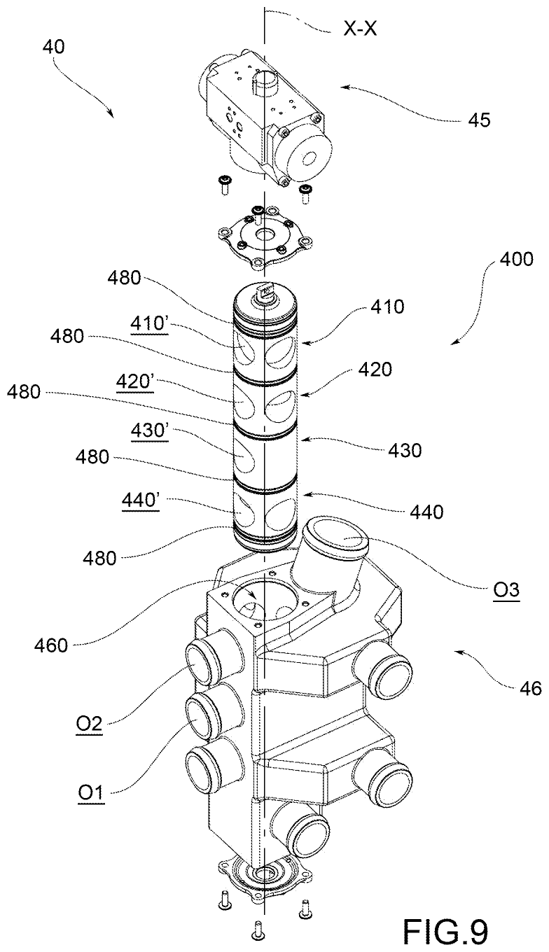

Preferably, the first working configuration is diagrammatically shown by way of example in FIG. 4′.

In the first working configuration, the fluidic control device 40 is configured to have two mutually separate fluidic circuits, suitable to supply working fluid to the first operating group 910 and the second operating group 920, respectively.

Preferably, the second working configuration is diagrammatically shown by way of example in FIG. 4′.

In the second working configuration, the fluidic control device 40 is configured to have the two pump groups 10, 20 operating in parallel to supply working fluid only to the third operating group 930.

Preferably, the third working configuration is diagrammatically shown by way of example in FIG. 4″′.

In the third working configuration, the fluidic control device 40 is configured to have the two pump groups 10, 20 which operate mutually in series to supply working fluid only to the second operating group 920.

According to a preferred embodiment, the fluidic control device 40 comprises a plurality of valve control elements 410, 420, 430, 440 fluidically positioned transversally related to a respective duct. According to the above, each working configuration corresponds to the regulation of each control valve element 410, 420, 430, 440 to a predetermined position.

In other words, the fluidic control device 40 comprises a control valve element 410, 420, 430, 440 at a respective duct, or at several ducts fluidically connected by the fluidic control device 40, or at two duct sections which are mutually separated by the fluidic control device 40.

According to a preferred embodiment, each control valve element 410, 420, 430, 440 is thus fluidically connected to a respective inlet and outlet hole for the fluidic connection. Preferably, some valve control elements are fluidically connected to more than one inlet and more than one outlet. Said inlet and outlet holes are, as shown in the appended figures, included in the fluidic control device 40 itself, e.g. in the device body 46 described below.

According to a preferred embodiment, each valve control element 410, 420, 430, 440 comprises a control axis X1-X1, X2-X2, X3-X3, X4-X4 relative to which it is regulable.

Preferably, each control valve element 410, 420, 430, 440 is regulable at a different angle relative to each respective control axis. In other words, each control valve element 410, 420, 430, 440 is positionable in a preferred angular position, in which it controls the passage of the respective amount of working fluid to a respective outlet O1, O2, O3.

Preferably, each control valve element 410, 420, 430, 440 has a control section 410′, 420′, 430′, 440′ therein, suitable to either allow or prevent the fluidic communication between at least one inlet hole with at least one outlet hole (reciprocally, fluidically connected to a respective duct or duct section) according to its positioning. Specifically, said control stretch 410′, 420′, 430′, 440′ is a passage passing through a full body. Preferably, the alignment of the control section 410′, 420′, 430′, 440′ with the respective inlet and outlet hole or holes causes the passage of working fluid; vice versa, the misalignment prevents the passage of working fluid.

Preferably, each control section 410′, 420′, 430′, 440′ extends perpendicular relative to the respective control axis X1-X1, X2-X2, X3-X3, X4-X4. Preferably, each full body of each control valve element 410, 420, 430, 440 has axial-symmetric development. Preferably, each full body of each control valve element 410, 420, 430, 440 is either cylindrical or spherical.

According to a preferred embodiment, each control section 410′, 420′, 430′, 440′ extends on a respective imaginary plane P1, P2, P3, P4. Preferably, each imaginary plane P1, P2, P3, P4 is substantially orthogonal to a respective control axis X1-X1, X2-X2, X3-X3, X4-X4.

According to a preferred embodiment, the fluidic control device 40 comprises a main axis X-X. Preferably, the fluidic control device 40 extends in length along said main axis X-X.

According to a preferred embodiment, each control axis X1-X1, X2-X2, X3-X3, X4-X4 lies on said main axis X-X. According to a preferred embodiment, each imaginary plane P1, P2, P3, P4 is orthogonal to the main axis X-X.

According to a preferred embodiment, the fluidic control device 40 comprises a main regulation member 400 comprising the control valve elements 410, 420, 430, 440 mutually, and integrally connected to one another.

Preferably, the main regulation member 400 consists of the full bodies of each control valve element 410, 420, 430, 440. In other words, the union of the full bodies of each valve control element 410, 420, 430, 440 make up the main regulation member 400.

According to a preferred embodiment, the main regulation member 400, between one control valve element and the other, comprises sealing elements 480 suitable for keeping the respective fluid amounts managed by each control valve element 410, 420, 430, 440 separated.

According to a preferred embodiment, the main regulation member 400 is shaped as a single cylinder which extends relative to the main axis X-X.

According to a preferred embodiment, the fluidic control device 40 comprises a control member 45 suitable to regulate the angular position of each control valve element 410, 420, 430, 440 relative to the respective control axis X1-X1, X2-X2, X3-X3, X4-X4.

Preferably, the control member 45 simultaneously controls the position of each valve control element 410, 420, 430, 440.

Preferably, in the embodiment with a single main regulation member 400, the union of multiple valve control elements 410, 420, 430, 440, control member 45 controls the position of the main regulation member 400 relative to the main axis X-X.

Preferably, the control member 45 is an electric motor connected to a respective inverter suitable to monitor its angular position.

According to a preferred embodiment, the thermal management assembly 1 comprises a device body 46 fluidically connected to the first outlet duct 12 and the second outlet duct 22 to receive the working fluid which flows in said ducts.

According to a preferred embodiment, the first outlet O1, the second outlet O2 and the third outlet O3 are obtained in said device body 46. The respective system inlet ducts 501, 502, 503 are connectable, through specific fittings, to said outlet ports and thus to said device body 46.

According to a preferred embodiment, the device body 46 accommodates, upstream of said ports, a plurality of control valve elements 410, 420, 430, 440. In other words, the inlet openings and outlet openings the passage of working fluid passage of which is managed by positioning the respective control valve element are obtained in the device body 46.

According to a preferred embodiment, the device body 46 is fluidically connected with the auxiliary duct 30 comprising a control valve element 430 controlled in a position in which it allows the passage of working fluid flow and a position in which it inhibits it.

In other words, the device body 46 is crossed by the aforesaid fluidic ducts, comprising the valve control elements 410, 420, 430, 440 specifically designed to manage the flow of the working fluid through either one duct or the other.

According to a preferred embodiment, the device body comprises a single regulation chamber 460 which extends along the main axis X-X and houses the control valve elements 410, 420, 430, 440 mutually and integrally connected to one another. Preferably, the main regulation member 400 is accommodated in the regulation chamber 460. Preferably, the regulation chamber 460 is shaped to have the walls complementary to the main regulation member 400. Preferably, the sealing elements 480 engage the walls delimiting the regulation chamber 460.

Furthermore, according to a preferred embodiment, the device body 46 comprises a regulation chamber 463 fluidically connected with the third outlet O3 and suitable to receive working fluid from the positioning of at least two valve control elements. In other words, in a preferred embodiment, e.g. corresponding to the second working configuration of the fluid control device 40 at least two valve control elements control the incoming working fluid flow from the first outlet duct 12 and the second outlet duct 22 towards said regulation chamber 463 and then towards the outlet O3.

Preferably, as shown by way of example, the fluidic control device 40 is extremely compact in size so that it is suitable to be accommodated in the engine compartment of a vehicle 900.

Preferably, the two pump groups have the characteristics described in document 102018000010971 by the Applicant, as also shown as an example in the appended figures.

Additionally, as already mentioned, the thermal management assembly which comprises the pump groups described above, and the fluidic control device described above is also the subject of the present invention.

Furthermore, as mentioned, the present invention also relates to the thermal regulation system 500 of a vehicle 900 which comprises said thermal management assembly 1 having the features described above. Said vehicle 900 comprises a first operating group 910, a second operating group 920, and a third operating group 930, while the thermal regulation system 500 comprises a plurality of system ducts 501, 502, 503, 551, 552, 553 suitable to be fluidically connected the first operating group 910, the second operating group 920 and the third operating group 930. Furthermore, said system ducts 501, 502, 503, 551, 552, 553 are suitable to be fluidically connected to the described thermal management assembly 1.

The present invention further relates to a vehicle 900 comprising a first operating group 910, e.g. an electric motor group, a second operating group 920, e.g. a battery group, and a third operating group 930, e.g. an endothermic engine group, and a thermal regulation system 500.

The present invention also relates to a hybrid-powered vehicle 900 which comprises a first operating group 910, which consists of an electric motor group, a second operating group 920, which consists of a battery group, and a third operating group 930, which consists of an endothermic engine group, and said thermal regulation system 500.

Innovatively, the fluidic control device, the thermal management system which comprises said management device, the thermal regulation system of a vehicle which comprises said regulation system, and the vehicle which comprises said thermal regulation system largely fulfill the purpose of the present invention by solving the problems which emerged in typical solutions of the prior art.

Indeed, advantageously, the thermal management assembly of the present invention allows the regulation of a plurality of operating groups of the vehicle.

Advantageously, the fluidic control device of the present invention allows simple management of the temperature of different operating groups of the vehicle, using only two pump groups.

Advantageously, the fluidic control device is easy to position in the vehicle, having compact dimensions and, therefore, compact overall dimensions.

Advantageously, the fluidic control device is cost-effective to manufacture.

Advantageously, the fluidic control device of the present invention manages the temperature of the vehicle in an extremely effective and flexible manner.

Advantageously, the thermal management of the present invention manages the temperature of the vehicle in a plurality of different operating conditions, i.e. both in motion and stationary.

Advantageously, the thermal management assembly is advantageously suitable, in the first configuration, to manage the temperature of both the electric motor group and the battery group, i.e. the “electric drive part” of a vehicle). In other words, in moving vehicle conditions at low rpm and/or low speeds, at which the vehicle is electrically powered, the thermal management assembly exclusively manages the temperature of said “electric drive part”.

Advantageously, the thermal management assembly is suitable, in the second configuration, to manage the temperature of an operating group such as the endothermic engine group. In other words, in moving vehicle conditions at high rpm and/or high speeds, at which the vehicle is powered endothermically, the thermal management assembly exclusively manages the temperature of said “endothermic drive part”.

Advantageously, the thermal management assembly is suitable, in the second configuration, to manage the temperature of an operating group such as the endothermic engine group by virtue of a double working fluid flow.

Advantageously, the thermal management assembly is suitable in the third configuration to cool an operating group with high load losses, such as the battery pack, by virtue of a double head.

Advantageously, in such a configuration, the temperature of the battery group is managed separately from the temperature management of the electric motor group and the endothermic engine group; e.g., such a configuration is applied in situations in which the vehicle is stationary, e.g. during the charging of the battery group, or during the ignition of the vehicle and the battery group.

Advantageously, the management of flows in ducts and circuits is extremely simplified.

Advantageously, with simple rotational operations, the fluidic control device is suitable to go from one configuration to another. Advantageously, with a single rotational operation, the fluidic control device is configurable in the desired working configuration.

It is apparent that, in order to meet contingent needs, those skilled in the art can make changes to the fluidic control device, the thermal management system, and the thermal regulation system, as well as the vehicle, all of which are contained within the scope of protection as defined in the following claims.

1-15. (canceled)

16. A fluidic control device of a thermal management assembly of a thermal regulation system of a vehicle, wherein said vehicle comprises a first operating group, a second operating group, and a third operating group fluidically connected to said thermal management assembly, and wherein said thermal management assembly comprises:
a first pump group that comprises a first inlet duct and a first outlet duct;
a second pump group that comprises a second inlet duct and a second outlet duct; and
an auxiliary duct that fluidically connects the first pump group and the second pump group;
wherein the fluidic control device is fluidically connected to the first inlet duct and the first outlet duct, to the second inlet duct and the second outlet duct and to the auxiliary duct and comprises a first outlet, a second outlet and a third outlet, respectively connectable to the first operating group, the second operating group and the third operating group;
wherein the fluidic control device is configurable in:
a first working configuration in which a flow of a working fluid is regulated through the first outlet and the second outlet respectively, preventing the working fluid from flowing through the third outlet and the auxiliary duct;
a second working configuration in which the flow of the working fluid is regulated through the third outlet, preventing the working fluid from flowing through the first outlet, the second outlet and the auxiliary duct; and
a third working configuration in which the flow of the working fluid is regulated through the auxiliary duct and the flow of the working fluid exiting through the second outlet is regulated, preventing the working fluid from flowing through the first outlet and the third outlet;
wherein the fluidic control device comprises a plurality of valve control elements fluidically positioned transversely to a respective duct, wherein each working configuration corresponds to a regulation of each valve control element in a predefined position; each valve control element comprising a control axis and being adjustable in a different angular position with respect to each respective control axis; and
wherein the fluidic control device further comprises a control member for adjusting the angular position of each one of the valve control elements with respect to the respective control axis.

17. The fluidic control device of claim 16, further comprising a main axis, wherein each control axis lies on said main axis.

18. The fluidic control device of claim 16, further comprising a main regulation member comprising, mutually integrally connected to each other, the valve control elements.

19. The fluidic control device of claim 16, wherein each valve control element comprises a control section through which the working fluid flows and as a function of the angular position of each valve control element allows or inhibits fluid communication between at least one inlet opening and at least an outlet opening.

20. The fluidic control device of claim 16, further comprising a device body in which the first outlet, the second outlet and the third outlet are formed, wherein the device body houses, upstream of said first, second and third outlets, said plurality of valve control elements, and wherein the device body further comprises inlet openings and outlet openings for fluidic connection with the valve control elements.

21. The fluidic control device of claim 20, wherein the device body is fluidically connected to the auxiliary duct comprising a valve control element controllable in a position in which it allows passage of the flow of the working fluid and a position in which it inhibits passage of the flow of the working fluid.

22. The fluidic control device of claim 20, wherein the device body comprises a regulation chamber fluidically connected to the third outlet and suitable for receiving the working fluid from positioning of at least two valve control elements.

23. The fluidic control device of claim 20, further comprising a main regulation member comprising, mutually integrally connected to each other, the valve control elements, wherein the device body comprises a single regulation chamber extending along a main axis and housing the valve control elements mutually integrally connected to each other.

24. A thermal management assembly of a thermal regulation system of a vehicle, wherein said vehicle comprises a first operating group, a second operating group, and a third operating group fluidically connectable to said thermal management assembly, wherein the thermal management assembly comprises:
a first pump group configured to control movement of a working fluid in the thermal management assembly, said first pump group comprising a first inlet duct and a first outlet duct;
a second pump group configured to control movement of the working fluid in the thermal management assembly, said second pump group comprising a second inlet duct and a second outlet duct;
an auxiliary duct fluidically connecting the first pump group and the second pump group;
a first inlet and a second inlet respectively fluidically connected to the first inlet duct and to the second inlet duct; and
a fluidic control device according to claim 16.

25. A thermal regulation system of a vehicle, wherein said vehicle comprises a first operating group, a second operating group, and a third operating group, wherein said thermal regulation system comprises:
a plurality of system ducts fluidically connected to the first operating group, the second operating group, and the third operating group; and
a thermal management assembly according to claim 24, fluidically connected to said plurality of system ducts.

26. A vehicle comprising a first operating group, a second operating group, a third operating group, and a thermal regulation system according to claim 25.

27. The vehicle of claim 26, wherein said vehicle is a hybrid-powered vehicle and wherein the first operating group comprises an electric engine group, the second operating group comprises a battery group, and the third operating group comprises an endothermic engine group.
